(19) United States
(12) Patent Application Publication
(10) Pub. No.: US 2026/0039767 A1
(43) Pub. Date: Feb. 5, 2026

(54) METHODS AND SYSTEMS FOR PROVIDING A MULTI-PARTY VIDEO SESSION

(71) Applicant: Adeia Guides Inc., San Jose, CA (US)

(72) Inventors: Serhad Doken, Bryn Mawr, PA (US); Tao Chen, Palo Alto, CA (US); Reda Harb, Tampa, FL (US)

(21) Appl. No.: 18/790,302

(22) Filed: Jul. 31, 2024

(51) Int. Cl. H04N 5/272; G06F 3/04817; G06T 7/00; G06V 40/10; H04N 5/262; H04N 23/90

(52) U.S. Cl. CPC H04N 5/272; G06F 3/04817; G06T 7/0002; G06V 40/10; H04N 5/2628; H04N 23/90; G06T 2207/10016; G06T 2207/30196

(57) ABSTRACT

The present disclosure relates to methods and systems, e.g., implemented by a server, for providing a video conferencing session, e.g., by displaying information (e.g., textual and/or image information) associated with a participant depicted in the video associated with the video conferencing session so as to make them more identifiable by the other participants. The server generates for display a first video captured from a first imaging device whose first field of view is configured to capture multiple participants of the video conferencing session, the multiple participants including at least a first participant. The server then captures a second video from a second imaging device, the second video depicting the first participant of the multiple participants. The server finally regenerates the first video to include a first display element, based on the second video, at a first position (e.g., a particular place or location) relative to a position (e.g., a particular place or location), in the first video, of the first participant.

### BACKGROUND

The present disclosure relates to methods and systems for providing a multi-party video session (e.g., a video conferencing session), e.g., by displaying information associated with a participant depicted in a video associated with the multi-party video session (e.g., video conferencing session). More particularly, but not exclusively, the present disclosure relates to methods and systems for providing a multi-party video session (e.g., a video conferencing session), wherein a live video captured from a first imaging device is regenerated, e.g., in real time during the multi-party video session (e.g., a video conferencing session), by overlaying information (e.g., textual and/or image information) associated with the participant of the multi-party video session (e.g., a video conferencing session).

### SUMMARY

In some approaches, information associated with an expected participant of a live event, e.g., a video conference, a news report, a sports event, etc., may be displayed, when the expected participant appears in the event, and remain visible for a limited period. The information may provide additional context for users, such as names, location, statistics, etc. associated with the participant. However, users who start viewing a live stream of the event after the limited period may miss viewing the additional information. While the live event is occurring, an unexpected participant may join the live event and information associated with the unexpected participant may not be available for display to help inform the users about the unexpected participant. In some approaches, after the live stream ends, the information may be manually added, e.g., during post-processing of the video, so as to make it available in the corresponding video on demand (VOD).

In some approaches, information associated with participants of a live event, e.g., a video conference session, may be displayed when each participant logs on to the video conference session from a respective location, e.g., via a respective personal online account on a video conferencing application used to implement the video conference session. Other participants may, however, be located in a room (e.g., huddle room) equipped with video conferencing equipment to allow the participants to join communally from the room. The participants in the room may log on to the video conference session via a room-associated online account on the video conferencing application. In such a case, information associated with the participants in the room is not available for display for the remote participants. Further, the video conferencing equipment may not have the means for identifying each participant in the room. Similarly, when another participant enters the room, the remote participants may be unaware of who the new participant is. Further still, some participants in the room may not be visible, e.g., in part, e.g., based on the relative positions of the participants in the huddle room and a camera of the video conferencing equipment.

In some cases, a remote participant of a video conferencing session may join the video conferencing session (or other type of live event) after a period for which participant information was displayed. This may result in the participant requesting such information, which may interrupt the video conferencing session and/or place undue operational demands on the video conferencing equipment or user equipment of a remote participant. In some examples, the video conferencing session (or other type of live event) may be recorded and stored for later access. However, it is desirable to avoid post-processing the recorded session to add extra participant information, or a user having to skip backwards through the recorded session to access displayed participant information. These and other scenarios result in the consumption of additional network resource, storage resource and operational demand.

Methods and systems, e.g., implemented by a server, are disclosed herein for providing a multi-party video session (e.g., a video conferencing session), e.g., by displaying information associated with a participant depicted in a video associated with the multi-party video session (e.g., video conferencing session). In particular, some methods and systems are disclosed herein for providing a multi-party video session (e.g., a video conferencing session), wherein a live video captured from a first imaging device is regenerated, e.g., in real time during the multi-party video session (e.g., a video conferencing session), by overlaying information (e.g., textual and/or image information) associated with the participant of the multi-party video session (e.g., a video conferencing session). In some instances, a conference in which participants in different locations are able to communicate with each other in sound and vision is a video conference also referred to as a multi-party video session.

In some examples, methods and systems, e.g., implemented by a server, provide, on a video related to a live event, information (e.g., textual and/or image-based information) associated with one or more participants of the live event, depicted in the video. In particular, some systems and methods disclosed herein provide an improved video by overlaying, e.g., in real time, on a video related to a live event, information (e.g., textual and/or image-based information) associated with participants of the live event, depicted in the video. In some approaches, the live event in question may be any live event involving at least one participant, such as a video conference, fireside chat, live panel talk, debate (e.g., political, historical or scientific debate), sports event, multiplayer gaming event, press conference, reality TV show, Tik Tok live streaming session e.g., wherein multiple parties are collaborating, streaming video shopping, etc. In some examples, a participant may be at least partially outside the field of view of least one imaging device capturing the live event. Alternatively, or additionally, a participant may be at least partially hidden by an object or another participant in the field of view of the imaging device. In some examples, the live event may be accompanied by commentary, e.g., from a commentor associated with the live event. In some examples, a commentator may be depicted in the video, e.g., as an overlay on to the video of the participants of the live event. In some approaches, a commentator may be outside the field of view of the at least one imaging device capturing the live event. Alternatively, a commentator may be within the field of view of the at least one imaging device capturing the live event and hidden by at least one object or commentator. Such methods and systems are to improve a user's consumption of a live event via the consumption of an improved video that provides a user with additional information (e.g., textual and/or image-based information) associated with the at least one person (e.g., participant or commentator) of the live event, or a subset of people, depicted or not in the video. In some examples, the additional information is displayed automatically on a video of the live event, e.g., in real time or near-real time, as a participant joins the event. In some examples, the additional information is displayed automatically on a video of the live event, e.g., in real time or near-real time, when or if a participant is at least partially obscured in the video of the live event. As such, to access the additional information, the users do not need to perform a fast-access playback operation (e.g., fast-rewinding, rewinding skip) when consuming a live video, schedule a recording of the live video in advance or consume a post-processed video related to the live video. In this manner, network resource, storage resource and/or operational demand, e.g., subsequent to generation of a video feed for the live event, may be reduced, and the user's access to the additional information is facilitated.

In some examples, a first video (e.g., a group shot) captured from a first imaging device whose first field of view is configured to capture multiple participants of a video conferencing session, is generated (e.g., at a server) for display (e.g., at a client device such as computing device of a huddle room comprising a large display or a personal user device such as mobile phone, tablet, laptop and the likes), the multiple participants including at least a first participant. (Image data generated by the first imaging device is forwarded to the server to generate the first video. The first video is regenerated e.g., at the server as a regenerated first video which includes at least a portion of the image data generated by the first imaging device.) A second video (e.g., a shot depicting mainly a single individual such as the first participant) captured from a second imaging device is received e.g., at the server, the second video depicting the first participant of the multiple participants. (In some instances, the second video is captured from a second imaging device e.g., prompted by the server). The first video is regenerated, e.g., at the server, to include a first display element, based on the second video, at a first position (e.g., a particular place or location) relative to a position (e.g., a particular place or location), in the first video, of the first participant. The first display element may include additional information associated with the first participant. (The regenerated first video includes at least a portion of the first video and a display element based on the second video, and is forwarded to the client device to be displayed on the client device.)

In some examples, the first video captured from the first imaging device is regenerated, e.g., in real time or near-real time, to include the first display element, based on the second video so as to provide additional information associated with the first participant. In some instances, the first display element comprises at least one portion of the second video, captured from the second imaging device, so as to depict the first participant in greater details and higher resolution in the regenerated first video than the depiction of the first participant in the first video. Thus, the overall quality of the regenerated first video is improved. The at least one portion of the second video may comprise, e.g., at least one frame from the second video, or at least one portion of one or more frames from the second video.

In some instances, the first display element comprises at least one portion of the second video, captured from the second imaging device, and textual and/or graphical information associated with the first participant so as to provide the additional information associated with the first participant. In some instances, the first display element may comprise a single piece (e.g., at least one portion of the second video or textual information such as one or more names) or multiple pieces (e.g., at least one portion of the second video, textual information such as one or more names and graphical information such as communication icon, ornamental icon). In some examples, multiple pieces of the display element may be displayed adjacent or connected to one another. In some examples, multiple pieces of the display element may be separated and displayed at respective locations. The relative location of the single piece or multiple pieces may evolve when the first participant changes posture or location. In some instances, the first display element is opaque or transparent. In some instances, the textual information comprises a tuple associated with the first participant, that in turn comprises at least one of a name (e.g., first name, surname, nickname), professional status (e.g., job title, unemployed status, student status, professional profile pulled from a social network e.g., LinkedIn®), organization (e.g., company, governmental organization, non-governmental organization, political movement) or one or more keywords (e.g., quote pronounced by the first participant, biographical stages of the first participant, at least one portion of the Curriculum Vitae of the first participant). In some instances, graphical information comprises at least one of selectable icon, non-selectable icon, or thumbnail. In some instances, selectable icons comprise communication icons such as text message icons, email icons, voice message icons. A user interface input from a participant of the video conferencing session other than the first participant selects a communication icon to access a graphical user interface (GUI). In some instances, upon a user interface input from a participant of the video conferencing session other the first participant, the GUI allows for the generation of a message (e.g., text, voice or video message), for the first participant, that is subsequently forwarded through a server to an application account associated with the first participant. The server determines at least one application that is currently active on a user device of the first participant and selects an application of the at least one application, that is compatible with the reception of the message. In some instances, the selected application is a chat application (e.g., Whatsapp®, TikTok®, Snapchat®, WeChat®, etc.). Upon a receipt of the message by the active application, the application sends, to the first participant, a notification (e.g., at least one of visual, audio and haptic-based notification) on the user device of the first participant to make the user aware of the receipt of the message from a participant of the video conferencing session. When the server determines that there is no application that is active, the server sends the message to an application that is compatible with the reception of the message and exhibits the highest recency of use. In some instances, non-selectable icons comprise e.g., logos (e.g., a logo related to the organization to which the first participant belongs), ornamental icons (e.g., emojis, avatars such as bitmoji), indicator icons (e.g., geometrical shapes linking elements from the first video to the second video). Each non-selectable icon can be selected by a single participant, the single participant being the participant being associated with the non-selectable icon. For each non-selectable icon, all participants but one cannot select the non-selectable icons. The selection of a communication icon allows for easily establishing a direct communication between the participant that selected the communication icon and the participant associated with the selected communication icon.

In some instances, the first imaging device comprises an in-room camera (e.g., a huddle room camera) integrated within a display device facing participants of the video conference session, located in a room (e.g., a huddle room), the display device presenting the first video or regenerated first video. The aperture of the first imaging device may be moveable so as to modify the size or position of the field of view of the first imaging device so as to modulate the amount of participants within the field of view or track one or more participants (e.g., their face) as in a Meta portal consumer device with Alexa built in. The field of view of the first imaging device (e.g., in-room camera, huddle room camera), is configured to capture any participant entering the room (e.g., huddle room). In some instances, the second imaging device comprises an in-room camera installed in the same room (e.g., huddle room) as the first imaging device, having a field of view different from the field of view of the first imaging device, the second imaging device being positioned differently from the first imaging device. In some instances, the field of view of the second imaging device is configured to capture a single participant. The aperture of the second imaging device may be moveable so as to modify the size or position of the field of view of the second imaging device so as to modulate the amount of participants within the field of view or track one or more participants (e.g., their face) as in a Meta portal consumer device with Alexa built in. In some instances, the second imaging device comprises a camera from a user device of the first participant, such as a mobile phone, a tablet, a laptop and the likes. In some instances, a presence of one or more participants in the room (e.g., huddle room) is determined based on an analysis of at least one portion of the first video using an imaging and/or audio recognition software. In some instances, the identity associated with the one or more participants (whose presence in the room, e.g., huddle room is determined) is determined, using an imaging and/or audio recognition software, based on the comparison of the at least one portion of the first video (comprising audio and visual information) with biometric information (e.g., a voice signature, a set of thumbnails depicting a face taken at different angles as if a camera was rotating around the face to generates the set of thumbnails) retrieved from a database mapping biometric information (e.g., a voice signature, a set of thumbnails depicting a face taken at different angles as if a camera was rotating around the face to generates the set of thumbnails) to identity of people (e.g., one or more names such as first name, surname, or nickname, passport number, driving license number, social security number or any textual information designating a single individual). In some instances, only a part of said database is employed based on a list of participants, established before forwarding invitations, to attend the video conferencing session. In some instances, only a part of said database is employed based on a list of participants established after people that were forwarded invitations to attend the video conferencing session confirmed or likely predicted their future participation to said video conferencing session. In some instances, if a participant is not identified based on the analysis of the at least one portion of the first video using the imaging and/or audio recognition software and the database (if not registered in the database), the participant is assigned an identity indicating that their identity is unknown, to which a number is appended so as to distinguish between multiple participants whose identity is unknown. In some instances, the database is generated by retrieving biometric information (e.g., a voice signature, a set of thumbnails depicting a face taken at different angles as if a camera was rotating around the face to generates the set of thumbnails) and identity of people (e.g., one or more names such as first name, surname, or nickname, passport number, driving license number, social security number or any textual information designating a single individual) from the personal user devices of the participants that plan to attend the video conferencing session. For example, participants can temporarily or permanently share biometric data (e.g., “faceID” data or “voice profile” data) that is stored on their personal user device (e.g., mobile phone) with the video conferencing application. For example, this data is already stored on their personal user device (e.g., iPhone®) to be used by native applications (e.g., Apple® apps) in order to e.g., unlock their personal user device or access a voice assistant (e.g., Siri®). In some instances, the video conferencing application prompts a potential participant to a video conferencing session to grant access to this data on a temporary (e.g., ‘disappearing biometrics’ feature) or permanent basis. In some instances, the access to this data is video conferencing session-based. In some instances, the database is anonymized e.g., for security purposes.

In some examples, the server forwards, to potential participants of the video conferencing session, a meeting invite comprising a location field indicating a room (e.g., huddle room). In some instances, the meeting invite comprises an option indicating whether the potential participants will be joining the video conferencing session from the room (e.g., huddle room) or individually (e.g., home, cubicle, etc.). Such option may only appear to potential participants whose location (e.g., in a directory) is the same as the location of the room (e.g., huddle room).

In some instances, the first participant enters the room (e.g., huddle room) after the start of the video conferencing session. At the start of the video conferencing session, the first video does not accordingly depict the first participant and the first video is not regenerated. The presence of the first participant is detected based on the analysis of the first video using an imaging and/or audio recognition software and the identity of the first participant is determined based on the analysis of the first video using the imaging and and/or recognition software, a database mapping biometric information (e.g., a voice signature, a set of thumbnails depicting a face taken at different angles as if a camera was rotating around the face to generates the set of thumbnails) to identity of people (e.g., one or more names such as first name, surname, or nickname, passport number, driving license number, social security number or any textual information designating a single individual), and possibly the established list of the participants. As the first participant enters the room (e.g., huddle room), the first video depicts the first participant, and the second video may depict the first participant if the first participant is within the field of view of the second imaging device.

In some instances, a first video captured from a first imaging device whose first field of view is configured to capture multiple participants of a video conferencing session, is generated for display, the multiple participants including at least a first participant. The first video is regenerated to include a first display element at a first position relative to the position, in the first video, of the first participant. In such instances, the first display element contains textual and/or graphical information associated with the first participant so as to provide additional information associated with the first participant. In some instances, the graphical information comprises e.g., a thumbnail depicting the first participant, a tapered shape (e.g., a triangle, trapezoid, etc.) indicating a connection between the first participant in the first video to the thumbnail depicting the first participant, one or more icons (e.g., a communication icon, ornamental icon) overlaid on the thumbnail depicting the first participant. In some instances, the textual information associated with the first participant comprises a tuple associated with the first participant, that in turn comprises at least one of a name of the first participant (e.g., at least one of first name, surname and nickname), professional status of the first participant (e.g., job title, unemployed status, student status, professional profile pulled from a social network e.g., LinkedIn®), organization (e.g., company, governmental organization, non-governmental organization, political movement) to which the first participant belongs or one or more keywords related to the first participant (e.g., quote pronounced by the first participant, biographical elements related to the first participant, at least one portion of the Curriculum Vitae of the first participant).

In some examples, the server captures the second video by at least determining that a first visibility score for the first participant in the first video is below a threshold visibility score. The server captures the second video by at least determining that a second visibility score for the first participant in the second video is above the threshold visibility score. The server captures the second video by at least causing the first video to be regenerated when the second visibility score is higher than the first visibility score.

In such examples, the desire to use a second imaging device to capture a second video depicting the first participant is motivated by having a low-quality depiction of the first participant in the first video corresponding to having the first visibility score for the first participant in the first video below the threshold visibility score. The regeneration of the first video to include the first display element based on the second video is, however, dependent upon having the second visibility score above the threshold visibility score and the first visibility score. Alternatively, using a second imaging device to capture a second video depicting the first participant is motivated by the provision of a first display element based on a second video representing a zoom-in of the first participant: greater details about the first participant may be visually accessible for the other participants.

In some instances, the threshold visibility score corresponds to at least one of a minimum visible proportion of a face area of a person, a minimum number of pixels comprising the visible proportion of the face area of the person and a minimum ratio of the number of pixels comprising the visible proportion of the face area to a total number of pixels in the frame. In some instances, the threshold visibility score is a default threshold visibility score. In some instances, the threshold visibility score is an adjustable, e.g., personalizable, threshold visibility score. In some instances, a user sets the threshold visibility score by selecting an adequate threshold visibility score while observing a set of calibration frames depicting each a respective visible proportion of a face area of person, a respective number of pixels comprising the visible proportion of the face area of the person, or a respective minimum ratio of the number of pixels comprising the visible proportion of the face area to a total number of pixels in the frame considered. A user that has initially consumed a video or video frame depicting a person whose visibility score is above the adequate threshold visibility score, has sufficient visual information about the person to recognize the person e.g., in a lineup. A user that has initially consumed a video or video frame depicting a person whose visibility score is below the adequate threshold visibility score, does not have sufficient visual information about the person to recognize the person e.g., in a lineup.

In some instances, the server regenerates the first video using at least one portion of the second video when the second visibility score of the first participant in the second video is above the first visibility score for the first participant in the first video, irrespective of the respective positions of the first visibility score and second visibility score relative to the threshold visibility score. In some instances, the server prompts the first participant to activate the second imaging device (e.g., personal device such as mobile phone, tablet, laptop and the likes) based on the determination that the first visibility score for the first participant in the first video is below the threshold visibility score. In some instances, the server prompts the first participant to select, among a plurality of second imaging devices (e.g., personal device of the first participant, personal devices of participants other than the first participant, in-room cameras), a second imaging device that captures a second video associated with the highest visibility score for the first participant so as to have the highest quality depiction of the first participant.

In some instances, the server determines that the first participant is speaking by determining, using the imaging and/or audio recognition software, that the lips of the first participant are moving and/or the voice of the first participant is sensed. The server prompts the second imaging device to capture a second video based on the determining that the first participant is speaking. The second video captured from the second imaging device is forwarded to the server. The server receives the second video and regenerates the first video to include a first display element, based on the second video, at a first position relative to a position, in the first video, of the first participant.

Hereby, the first display element in the regenerated first video depicts the first participant speaking, allowing the other participants to experience a situation close to a face-to-face conversation with the first participant.

In some examples, the server determines that a first visibility score for the first participant in the first video is below a threshold visibility score. Additionally, the server determines an identity of the first participant having the first visibility score below the threshold visibility score. Furthermore, the server accesses a thumbnail associated with the identified first participant. In addition, the server regenerates the first video to include the thumbnail.

In such examples, the server includes, in the regenerated first video, a thumbnail, depicting the first participant in greater details and in higher resolution than in the first video, when the first visibility score for the first participant in the first video is below the threshold visibility score and the server has identified the first participant using at least one portion of the first video, an imaging and/or audio recognition software and a database. In some instances, the database comprises information (e.g., biometric information, biographical information) associated with people and identity associated with people (e.g., one or more names such as first name, surname, or nickname, passport number, driving license number, social security number or any textual information designating a single individual): information associated with a respective person is mapped to an identity associated with the respective person. In some instances, biometric information associated with a respective person comprises e.g., a voice signature of the respective person, a set of thumbnails depicting a face of the respective person taken at different angles as if a camera was rotating around the face of the person to generate the set of thumbnails. In some instances, the set of thumbnails comprises high-quality and high-resolution thumbnails of the respective person that are part of the first display element included in the regenerated first video. In some instances, biographical information associated with a respective person comprises at least one of e.g., professional status (e.g., job title, unemployed status, student status, professional profile pulled from a social network e.g., LinkedIn®) of the respective person, organization (e.g., company, governmental organization, non-governmental organization, political movement) to which the respective person belongs and one or more keywords related to the person (e.g., quote pronounced by the respective person, biographical elements related to the respective person, biographical stages of the first participant, at least one portion of the Curriculum Vitae of the first participant). In some instances, the database is anonymized e.g., for security purpose. In some instances, the thumbnail included in the regenerated first video also comprises e.g., an identity associated with the first participant and/or biographical information associated with the first participant.

In some instances, the server includes a thumbnail, depicting the first participant in greater details and in higher resolution than in the first video, until the second imaging device becomes available to provide the second video depicting the first participant. In some instances, the server includes a thumbnail, depicting the first participant in greater details and in higher resolution than in the first video, until the server determines that the second visibility score for the first participant in the second video is higher than the first visibility score for the first participant in the first video. When the server determines that the second visibility score for the first participant in the second video is higher than the first visibility score for the first participant in the first video, the server removes the thumbnail so as to present the first display element based on the second video, e.g., a live image of the first participant attending the video conferencing session.

In some examples, the server determines the first visibility score by at least determining, based on a frame of the first video, at least one of a visible proportion of a face area of the first participant, a number of pixels comprising the visible proportion of the face area of the first participant, and a ratio of the number of pixels comprising the visible proportion of the face area to a total number of pixels in the frame.

In some examples, the server determines the second visibility score by at least determining, based on a frame of the second video, at least one of a visible proportion of a face area of the first participant, a number of pixels comprising the visible proportion of the face area of the first participant, and a ratio of the number of pixels comprising the visible proportion of the face area to a total number of pixels in the frame.

The server may then correlate the visible proportion of a face area of the first participant in a frame of the first video and in a frame of the second video to the first visibility score and second visibility score, respectively, the visible proportion of the face area and the frame area being expressed both in numbers of pixels. The visible proportion of the face area of the first participant should be understood to mean the proportion of the face area of the first participant depicted in a frame of a video e.g., first video or second video, the face area comprising a lip area, eyes area, nose area, ear area, hair area. The higher the proportion of the face area of the first participant in a video frame is, the more recognizable, for the participants, the first participant is in the video frame. Similarly, the higher the proportion of the face area of the first participant in multiple consecutive video frames (or video) is, the more recognizable, for the participants, the first participant is in the multiple consecutive video frames.

In some instances, the server periodically (e.g., every 30 seconds, minute, 2 minutes, etc.) determines the first and second visibility scores as the posture of the first participant and/or orientation of the first participant's head relative to the first and second imaging devices evolve during the video conferencing session. The periodical determination of the first and second visibility scores may result in the use of the first display element based on the second video or the thumbnail depicting the first participant.

In some instances, in response to turning on the second imaging device, the server determines first and second visibility scores for the first participant in the first and second videos, respectively and compares them so as to determine the basis (e.g., second video or thumbnail of the first participant) for the first display element. Concomitantly with or after the determination of the first and second visibility scores, the server determines the identity of the first participant. As soon as the server establishes the identity of the first participant, the server stops determining the first and second visibility scores for the first participant in order to decrease the amount of network resources and processing resources used by the video conferencing session. The server feeds the identity of the first participant back to the in-room camera/image processing module so as to alter the processing of the first video and the second video, which now excludes the determination of the first and second visibility scores for the first participant in first and second videos, respectively. Additionally, the server may prompt participants to select the basis of the first display element (e.g., second video or thumbnail of the first participant) and thus the type of regenerated first video they want presented on their personal user device or the large display device of the computing device located in the huddle room. Some participants may prefer watching the first participant as they currently are and would tolerate to be presented a regenerated first video whose first display element is based on a second video of low quality (while providing a zoom-in depiction of the first participant compared to the first video). Other participants may prefer watching the thumbnail of the first participant.

In some examples, the server determines information associated with the first participant. Additionally, the server regenerates the first video to include a second display element displaying the information at a position relative to the first display element.

In this way, the server presents, on the regenerated first video, information associated with the first participant so as to provide the participants of the video conferencing session more comprehensive information about the first participant. In some instances, the information associated with the first participant comprises at least one of identity associated with the first participant (e.g., one or more names such as first name, surname, or nickname, passport number, driving license number, social security number or any textual information designating a single individual), biometric information associated with the first participant (e.g., a voice signature of the respective person, a set of thumbnails depicting a face of the respective person taken at different angles as if a camera was rotating around the face of the person to generate the set of thumbnails) and biographical information associated with the first participant (at least one of professional status—e.g., job title, unemployed status, student status, professional profile pulled from a social network e.g., LinkedIn®—of the first participant, organization—e.g., company, governmental organization, non-governmental organization, political movement—to which first participant belongs and one or more keywords related to the first participant—e.g., quote pronounced by the first participant, biographical elements related to the first participant).

In some instances, the server regenerates the first video to include a second display element displaying the information associated with the first participant at a position relative to the first display element, when the first participant speaks during the video conferencing session.

In some examples, the first display element is configured to obscure the first participant depicted in the first video. In this manner, the server presents a regenerated first video that is easier to comprehend for the participants of the video conferencing session, since the first participant is not depicted in multiple locations in the first video.

In some instances, the server decomposes the first video to isolate a first portion of the first video depicting the first participant, generates the first display element and recomposes the first video to include the first display element and not the first portion of the first video. In some instances, the shape of a portion of the first display element is based on the shape of the first portion of the first video containing the first participant.

In some examples, the server regenerates the first video to include a third display element, wherein the third display element comprises a selectable icon configured to enable communication with the first participant. Additionally, the server receives a user interface input selecting the selectable icon. The server may establish communication with the first participant via a communication application.

In such examples, a participant of the video conferencing session directly communicates with the first participant by selecting a selectable communication icon to access a GUI, from which the participant forwards a message (e.g., text, voice or video message) to the first participant. In some instances, the communication application used is a sub-application of a video conferencing application supporting the video conferencing session or a communication application other than the sub-application of the video conferencing application.

In some examples, the server establishes communication with the first participant by at least determining that the second imaging device is part of a user device of the first participant. The server may establish communication with the first participant by at least determining that at least one communication application is active on the user device of the first participant. The server may establish communication with the first participant by at least selecting the at least one communication application to receive the communication.

The server may determine that the first participant has a user device comprising a camera configured to capture the second video, which communication application is active on the first participant's user device and susceptible to receive, in real time, a message (e.g., text, voice or video message) and to notify the first participant of the receipt of a message from a participant of the video conferencing session.

In some examples, the server establishes communication with the first participant by at least determining that the first participant has a user device. The server may establish communication with the first participant by at least determining that at least one communication application is active on the user device of the first participant. The server may establish communication with the first participant by at least selecting the at least one communication application to receive the communication.

In some examples, the server determines that a second visibility score for the first participant in the second video is below a first visibility score for the first participant in the first video. The server determines information associated with the first participant. The server regenerates the first video to include a fourth display element and a fifth display element, wherein the fourth display element comprising the information and the fifth display element indicating a connection between the fourth display element and a depiction of the first participant in the first video.

In this way, when a second visibility score for the first participant in the second video is below a first visibility score for the first participant in the first video, the server labels, in the regenerated first video, the depiction of the first participant by overlaying, on the regenerated first video, the fifth display element e.g., a tapered shape such as a triangle, trapezoid, etc. and the fourth display element e.g., information associated with the first participant, the tapered shape indicating a connection between the depiction of the first participant in the regenerated first video and the information associated with the first participant. The labelling allows for specifying further the first participant, which makes the first participant more recognizable for the participants of the video conferencing session, and compensates for the absence of at least a portion of the second video in the regenerated first video (since the second visibility score is below the first visibility score). The fifth display element assists in the mapping of the first participant depiction to the information associated with the first participant.

In some instances, the information associated with the first participant comprises at least one of identity associated with the first participant (e.g., one or more names such as first name, surname, or nickname, passport number, driving license number, social security number or any textual information designating a single individual), biometric information associated with the first participant (e.g., a voice signature of the respective person, a set of thumbnails depicting a face of the respective person taken at different angles as if a camera was rotating around the face of the person to generate the set of thumbnails) and biographical information associated with the first participant (at least one of professional status—e.g., job title, unemployed status, student status, professional profile pulled from a social network e.g., LinkedIn®—of the first participant, organization—e.g., company, governmental organization, non-governmental organization, political movement—to which first participant belongs and one or more keywords related to the first participant—e.g., quote pronounced by the first participant, biographical elements related to the first participant).

In some examples, the server regenerates the first video by at least including, in the regenerated first video, a sixth display element indicating a connection between the first display element and a depiction of the first participant in the first video.

In some examples, the server presents a regenerated first video in which the first display element based on the second video and the depiction of the first participant in the regenerated first video are somehow connected by a sixth display element e.g., a tapered shape such as a triangle, trapezoid, etc. This allows for specifying further the first participant, making the first participant more recognizable for the participants of the video conferencing session.

In some examples, the server detects that a new participant in the huddle room has actively joined the video conference session from a personal user device (e.g., mobile phone, tablet, laptop and the likes). The server determines that the second visibility score for the first participant in the second video is higher than the threshold visibility score and the first visibility score for the first participant in the first video. The server prompts the first imaging device (e.g., in-room camera, huddle room camera) to change the frame size and/or rate of the first video captured from the first imaging device (e.g., zoom in) so as to depict the participants (other than the first participant) present in the huddle room in greater details. The server regenerates the first video by obscuring the depiction of the first participant with the first display element based on at least one portion of the second video.

In this way, the regenerated first video may comprise one or more windows, each window depicting an individual in-room participant (e.g., first participant) and e.g., a communication icon (that is selectable by another individual participant) to establish communication with the individual in-room participant. This allows for creating a communication channel for each detected participant, even if a detected participant did not attend the video conferencing session from their own personal user devices (e.g., mobile phones, tablets, laptops and the likes). In some instances, the server generates for display information (e.g., metadata, identity, biometric information, biographical information) associated with the individual in-room participant (e.g., first participant) and associates them with the corresponding window.

In some instances, the server establishes a chat session between two participants via the meeting invite for the video conferencing session that the participant received, or the confirmation response to the meeting invite. This allows, for a participant that does not have the video conferencing application active or installed, to still receive message sent to them directly.

In some instances, in response to the regeneration of the first video as one or more windows (each window depicting an individual in-room participant e.g., first participant), the server generates for display a graphical user interface prompting participants to select information (e.g., identity) associated with themselves so as to ‘sign in’ for the video conferencing session. (This could even assist the server in the identification of the participants.) Alternatively, the server may detect, in a client device (e.g., a personal user device), the meeting invite (e.g., Outlook®) for the video conferencing session that the participant received and accepted so as to determine the identity of the participant. Alternatively, the server may detect, in a client device (e.g., a personal user device), an ID (e.g., Apple® ID) that may be associated with multiple appliances and/or apps so as to determine the identity of the participant.

In some examples, the aforementioned methods and systems may be used to regenerate, when the video conferencing session has ended, the first video (related to the video conferencing session) captured (during the video conferencing session) from the first imaging device, by storing all videos (related to the video conferencing session) captured during the video conferencing session, such as first video captured from first imaging device, second video(s) captured from one or more second imaging devices (e.g., any additional in-room cameras installed in the huddle room, camera(s) from personal user devices). Hereby, the aforementioned methods and systems can be used for post-processing of videos. The resulting videos, comprising the regenerated first videos, can then be stored for future replay. In some instances, the communication icon is selectable by an individual, when the individual is presented the regenerated first video obtained after post-processing, so as to establish a communication with a participant of the video conferencing session after the video conferencing session has ended via a communication application that is active. In some instances, the active communication application may be the video conferencing application. In some instances, the active communication application is a communication application different from the video conferencing application.

### BRIEF DESCRIPTION OF THE DRAWINGS

FIG. 1 shows four examples resulting from the provision of a video conferencing session in accordance with some implementations of the disclosure;

FIG. 2 illustrates a first-name/at-least-one-portion-of-a-second-video overlay from regenerated first video 102d in accordance with some implementations of the disclosure;

FIG. 3 depicts a flowchart describing an example for providing a video conferencing session in accordance with some implementations of the disclosure;

FIG. 4 illustrates a block diagram of an example system for providing a video conferencing session in accordance with some implementations of the disclosure;

FIG. 5 represents a flowchart describing an example for providing a video conferencing session in accordance with some implementations of the disclosure; and

FIG. 6 depicts a flowchart describing an example for providing a video conferencing session in accordance with some implementations of the disclosure.

### DETAILED DESCRIPTION

Using a video conferencing application, a person sets up, at a user computer, a video conferencing session at a given date and time, then forwards, to people, an invitation to attend the video conferencing session. At least a subset of people accept the invitation or respond that they may tentatively join the video conferencing session so as to become participants of the video conferencing session. A video conferencing server, in communication with the user computer via a communication network e.g., WAN or LAN, records the future occurrence of the scheduled video conference session and establishes the list of participants to the video conferencing session. Some participants will attend the video conferencing session from a same room e.g., huddle room equipped with a computing device comprising a camera, a large display device (to display live streams captured from e.g., the camera and other cameras capturing images of participants of a video conferencing session located inside or outside the huddle room), speakers, a microphone, a computer-related medium storing the video conferencing application and a processing circuitry to run e.g., the video conferencing application. In some instances, some participants in the huddle room may have a personal user device e.g., a mobile phone, a tablet, a laptop or the likes equipped at least with a display device, a physical or virtual keyboard, a computer-related medium storing the video conferencing application and other communication applications that may be active and a processing circuitry to run e.g., the video conferencing application. During the video conferencing session, the large display device simultaneously presents a plurality of live videos, a live video for each location where one or more participants attend the video conferencing session. Other participants will attend the video conferencing session alone from a single place (e.g., the comfort of their home, a cubicle, etc.) and use a personal user device equipped with a display device, camera, speakers, microphone and a computer-related medium storing the video conferencing application and a processing circuitry to run e.g., the video conferencing application. The video conferencing server has access to a database mapping identity of people (e.g., one or more names such as first name, surname, or nickname, passport number, driving license number, social security number or any textual information designating a single individual) to information (e.g., biometric information, biographical information) associated with people. In some instances, biometric information associated with a person comprises e.g., a voice signature of the person, a set of thumbnails depicting a face of the person taken at different angles as if a camera was rotating around the face to generate the set of thumbnails. In some instances, biographical information associated with a respective person comprises at least one of e.g., professional status (e.g., job title, unemployed status, student status, professional profile pulled from a social network e.g., LinkedIn®) of the respective person, organization (e.g., company, governmental organization, non-governmental organization, political movement) to which the respective person belongs and one or more keywords related to the person (e.g., quote pronounced by the respective person, biographical elements related to the respective person, biographical stages of the first participant, at least one portion of the Curriculum Vitae of the first participant). In some instances, the database is anonymized e.g., for security purpose.

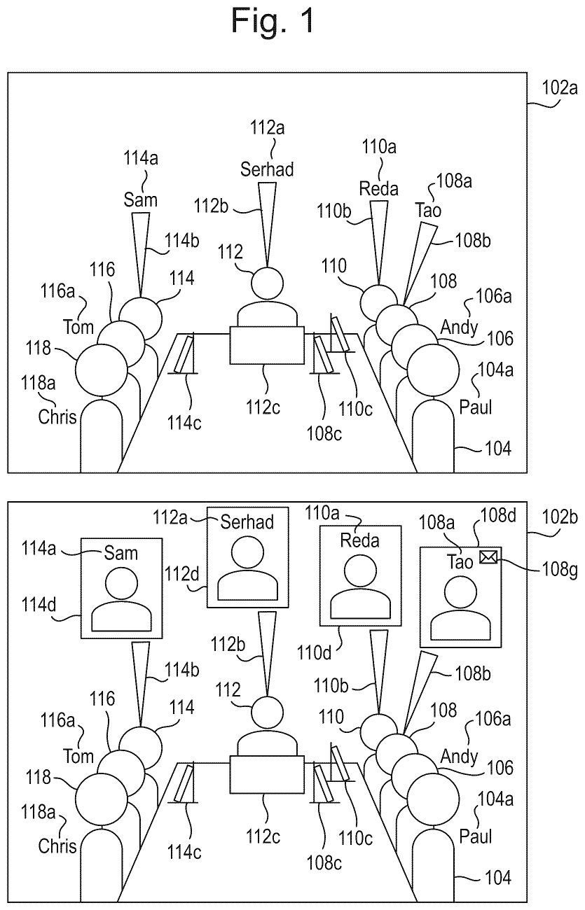

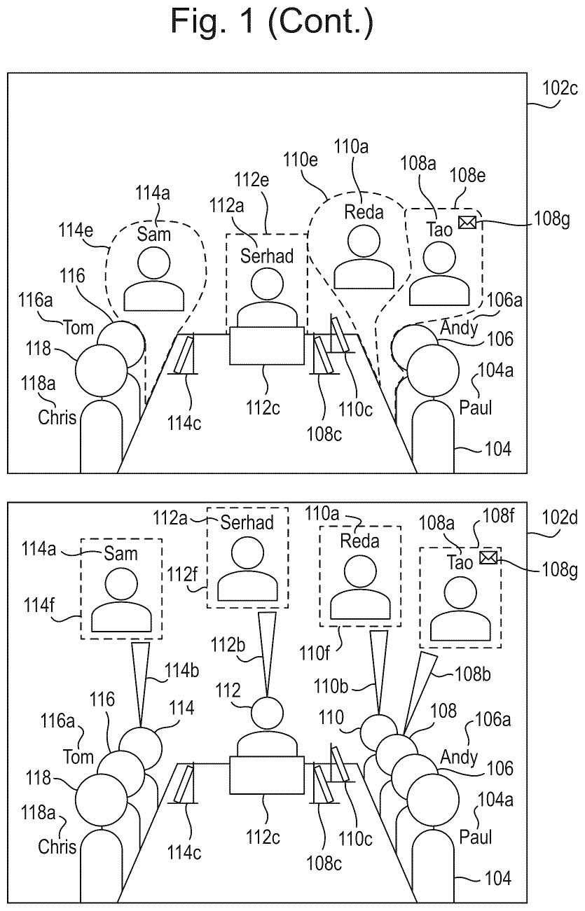

FIG. 1 shows four examples 102a-102d resulting from the provision of a video conferencing session in accordance with some implementations of the disclosure. Examples 102a-102d represents regenerated first videos presenting specific display elements.

Regenerated first video 102a depicts eight participants (represented by participant depictions 104, 106, 108, 110, 112, 114, 116 and 118, respectively) seating in a same room around a table. Participants (represented by participant depictions 108, 110, 112 and 114, respectively) face personal user devices (represented by personal user device depictions 108c, 110c, 112c and 114c, respectively) that are placed on the table. Other participants (represented by participant depictions 104, 106, 116 and 118) do not have a personal user device at disposal. After having identified each participant depiction using an image and/or audio recognition software and a database (and possibly a list of the video conferencing session attendees), the video conferencing server maps, in regenerated first video 102a, for each participant, a respective overlay indicating a first name associated with a participant depiction, to a respective participant depiction such that the participant depiction with which the first name is associated matches the respective participant depiction. First-name overlays 104a, 106a, 116a and 118a “float” nearby participant depiction 104, 106, 116 and 118, respectively. First-name overlays 108a, 110a, 112a and 114a, are spaced apart, from participant depictions 108, 110, 112 and 114, respectively, by tapered-shape overlays 108b, 110b, 112b and 114b, respectively. Each tapered-shape overlay (e.g., tapered shape, triangle, trapezoid, etc.) indicates a connection between a respective participant depiction and the first-name overlay mapped to the respective participant depiction: the mapping of a participant depiction to a respective first-name overlay is materialized by a respective tapered-shape overlay, which is particularly useful when the participant depiction in question has a low visibility score in both the video captured from the huddle room camera and the video captured from a camera of a personal user device (this comprises the case where the participant does not have a personal user device at disposal). In some instances, each first-name overlay may comprise a communication icon selectable by any participant of the video conferencing session to directly communicate, during the video conferencing session, with the participant mapped to the selected first name/thumbnail overlay.

Regenerated first video 102b depicts eight participants (represented by participant depictions 104, 106, 108, 110, 112, 114, 116 and 118, respectively) seating in a same room around a table. Participants (represented by participant depictions 108, 110, 112 and 114, respectively) face personal user devices (represented by personal user device depictions 108c, 110c, 112c and 114c, respectively) that are placed on the table. Other participants (represented by participant depictions 104, 106, 116 and 118, respectively) do not have a personal user device at disposal. After having identified each participant depiction using an image recognition software and a database (and possibly a list of the video conferencing session attendees), the video conferencing server maps, in regenerated first video 102b, for some participant depictions, a first-name overlay indicating a first name associated with a participant depiction, to a respective participant depiction such that the participant depiction with which the first name is associated matches the respective participant depiction. First-name overlays 104a, 106a, 116a and 118a “float” nearby participant depiction 104, 106, 116 and 118, respectively. After having identified each participant depiction using an image and/or audio recognition software and a database (and possibly a list of the video conferencing session attendees), the video conferencing server maps, in regenerated first video 102b, for some participant depictions, a first-name/thumbnail overlay comprising a first-name overlay and a thumbnail overlay (both associated with a same participant depiction), to a respective participant depiction such that the same participant depiction with which the first name and thumbnail are associated matches the respective participant depiction. First-name/thumbnail overlays 108d, 110d, 112d and 114d, (each comprising a thumbnail overlay and a first-name overlay 108a, 110a, 112a and 114a) are spaced apart, from participant depictions 108, 110, 112 and 114, respectively, by tapered-shape overlays 108b, 110b, 112b and 114b, respectively. Each tapered-shape overlay (e.g., tapered shape, triangle, trapezoid, etc.) indicates a connection between a respective participant depiction and the first-name overlay mapped to the respective participant depiction: the mapping of a participant depiction to a respective first-name overlay is materialized by a respective tapered-shape overlay, which is particularly useful when the participant depiction in question has a low visibility score in both the first video captured from the huddle room camera and the second video captured from a camera of a personal user device (this comprises the case where the participant does not have a personal user device at disposal). First-name/thumbnail overlay 108d comprises a first-name overlay 108a, a thumbnail overlay and a communication icon 108g selectable by any participant of the video conferencing session to directly communicate, during the video conferencing session, with the participant depicted as participant depiction 108. In some instances, each first-name/thumbnail overlay may comprise a communication icon selectable by any participant of the video conferencing session to directly communicate, during the video conferencing session, with the participant mapped to the selected first name/thumbnail overlay.

Regenerated first video 102c depicts eight participants (represented by participant depictions 104, 106, 108, 110, 112, 114, 116 and 118, respectively) seating in a same room around a table. Participants (represented by participant depictions 108, 110, 112 and 114, respectively) face personal user devices (represented by personal user device depictions 108c, 110c, 112c and 114c, respectively) that are placed on the table. Other participants (represented by participant depictions 104, 106, 116 and 118, respectively) do not have a personal user device at disposal. After having identified each participant depiction using an image recognition software and a database (and possibly a list of the video conferencing session attendees), the video conferencing server maps, in regenerated first video 102b, for some participant depictions, a first-name overlay indicating a first name associated with a participant depiction, to a respective participant depiction such that the participant depiction with which the first name is associated matches the respective participant depiction. First-name overlays 104a, 106a, 116a and 118a “float” nearby participant depiction 104, 106, 116 and 118, respectively. After having identified each participant depiction using an image and/or audio recognition software and a database (and possibly a list of the video conferencing session attendees), the video conferencing server maps, in regenerated first video 102b, for some participant depictions, a first-name/at-least-one-portion-of-second-video overlay comprising a first-name overlay and an at-least-one-portion-of-a-second-video overlay (both associated with a same participant depiction), to a respective participant depiction such that the same participant depiction with which the first name and thumbnail are associated matches the respective participant depiction. First-name/at-least-one-portion-of-a-second-video overlays 108e, 110e, 112e and 114e, (each comprising an at-least-one-portion-of-second-video overlay and a first-name overlay 108a, 110a, 112a and 114a) are superimposed on participant depictions 108, 110, 112 and 114, respectively so as to obscure participant depictions 108, 110, 112 and 114, respectively. Cameras of personal user devices 108c, 110c, 112c and 114c capture second videos depicting mainly participant depiction 108, 110, 112 and 114, respectively. When the visibility score for a participant in a second video exceeds the visibility score for said participant in the first video, an overlay based on at least one portion of the second video associated with said participant (in other words depicting mainly said participant) is overlaid to obscure the depiction of said participant in the first video prior to the regeneration of the first video. This allows for having a number of participant depiction equal to the number of participants in the huddle room, which makes regenerated first video 102c tidier and easier to comprehend for the participants of the video conferencing session. First-name/at-least-one-portion-of-a-second-video overlay 108e comprises a first-name overlay 108a, an at-least-one-portion-of-a-second-video overlay and a communication icon 108g selectable by any participant of the video conferencing session to directly communicate, during the video conferencing session, with the participant depicted as participant depiction 108. In some instances, each first-name/at-least-one-portion-of-a-second-video overlay may comprise a communication icon selectable by any participant of the video conferencing session to directly communicate, during the video conferencing session, with the participant mapped to the selected first-name/at-least-one-portion-of-a-second-video overlay.

Regenerated first video 102d depicts eight participants (represented by participant depictions 104, 106, 108, 110, 112, 114, 116 and 118, respectively) seating in a same room around a table. Participants (represented by participant depictions 108, 110, 112 and 114) face personal user devices (represented by personal user device depictions 108c, 110c, 112c and 114c, respectively) that are placed on the table. Other participants (represented by participant depictions 104, 106, 116 and 118, respectively) do not have a personal user device at disposal. After having identified each participant depiction using an image recognition software and a database (and possibly a list of the video conferencing session attendees), the video conferencing server maps, in regenerated first video 102d, for some participant depictions, a first-name overlay indicating a first name associated with a participant depiction, to a respective participant depiction such that the participant depiction with which the first name is associated matches the respective participant depiction. First-name overlays 104a, 106a, 116a and 118a “float” nearby participant depiction 104, 106, 116 and 118, respectively. After having identified each participant depiction using an image and/or audio recognition software and a database (and possibly a list of the video conferencing session attendees), the video conferencing server maps, in regenerated first video 102d, for some participant depictions, an overlay comprising a first name and at least one portion of a second video (the second video being captured from a camera of a personal user device) both associated with a same participant depiction, to a respective participant depiction such that the same participant depiction with which the first name and thumbnail are associated matches the respective participant depiction. First-name/at-least-one-portion-of-a-second-video overlays 108f, 110f, 112f and 114f (each comprising a first-name overlay 108a, 110a, 112a and 114a and an at-least-one-portion-of-a-second-video overlay) are spaced apart, from participant depictions 108, 110, 112 and 114, respectively, by tapered-shape overlays 108b, 110b, 112b and 114b, respectively. Cameras of personal user devices 108c, 110c, 112c and 114c capture second videos depicting mainly participant depictions 108, 110, 112 and 114, respectively. Each tapered-shape overlay (e.g., tapered shape, triangle, trapezoid, etc.) indicates a connection between a respective participant depiction and the first-name/at-least-one-portion-of-a-second-video overlay mapped to the respective participant depiction: the mapping of a participant depiction to a respective first-name/at-least-one-portion-of-a-second-video overlay is materialized by a respective tapered-shape overlay, which is particularly useful when the visibility score for a participant in the first video captured from the huddle room camera is lower than the visibility score for the same participant in the second video captured from the camera of a personal user device. Regenerated first video 102d appears different than regenerated first video 102c (as there are more participant depictions than participants in the former) but faithfully depicts the arrangement of the participant depictions around the table depiction. First-name/at-least-one-portion-of-a-second-video overlay 108d comprises a first-name overlay 108a, at least one portion of a second video overlay and a communication icon 108g selectable by any participant of the video conferencing session to directly communicate, during the video conferencing session, with the participant depicted as participant depiction 108. In some instances, each first-name/at-least-one-portion-of-a-second-video overlay may comprise a communication icon selectable by any participant of the video conferencing session to directly communicate, during the video conferencing session, with the participant mapped to the selected first-name/at-least-one-portion-of-a-second-video overlay.

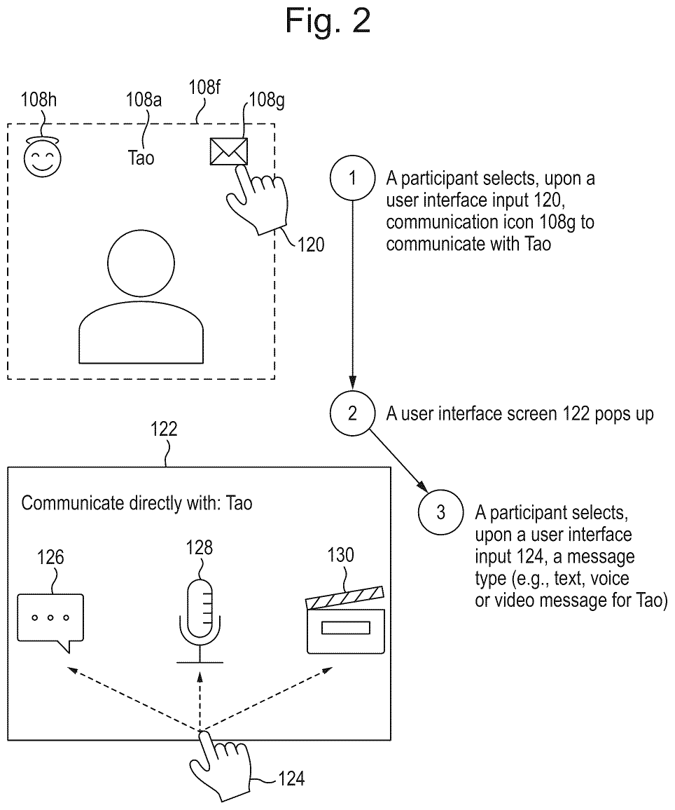

FIG. 2 illustrates a first-name/at-least-one-portion-of-a-second-video overlay 108f from regenerated first video 102d in accordance with some implementations of the disclosure. First-name/at-least-one-portion-of-a-second-video overlay 108f comprises a first-name overlay 108a, an at-least-one-portion-of-a-second video overlay (comprising at least one portion of a second video captured from personal user device 108c and depicting mainly participant represented by participant depiction 108), a communication icon 108g and an ornamental icon 108h depicting a happy-angel emoji. First-name/at-least-one-portion-of-a-second-video overlay 108f appears on display of a personal user device of a participant located outside the huddle room, the personal user device being in communication with the video conferencing server, via the communication network e.g., LAN or WAN.

In some instances, the participant's personal user device selects, upon a first user interface input 120, a communication icon 108g to communicate with participant ‘Tao’ represented by participant depiction 108 in regenerated first video 102d. Upon first user interface input 120, the participant's personal user device presents a user interface screen 122 comprising an expression ‘Communicate directly with: Tao’ and three message types i.e., a text message 126, a voice message 128 and a video message 130. The participant's personal user device then selects, upon a second user interface input 124, one of the three message types, to generate another user interface screen allowing for, depending upon the selected message type, the typing or recording, at their personal user device, of the participant's message for Tao. The participant's personal user device subsequently forwards, upon a third user interface input, the message for Tao to Tao's personal online account relating to a communication application that is active on Tao's personal user device 108c during the video conferencing session. A notification (e.g., audio and/or visual notification that may occur with or without vibrations) is received so as to notify Tao of the receipt of a message.

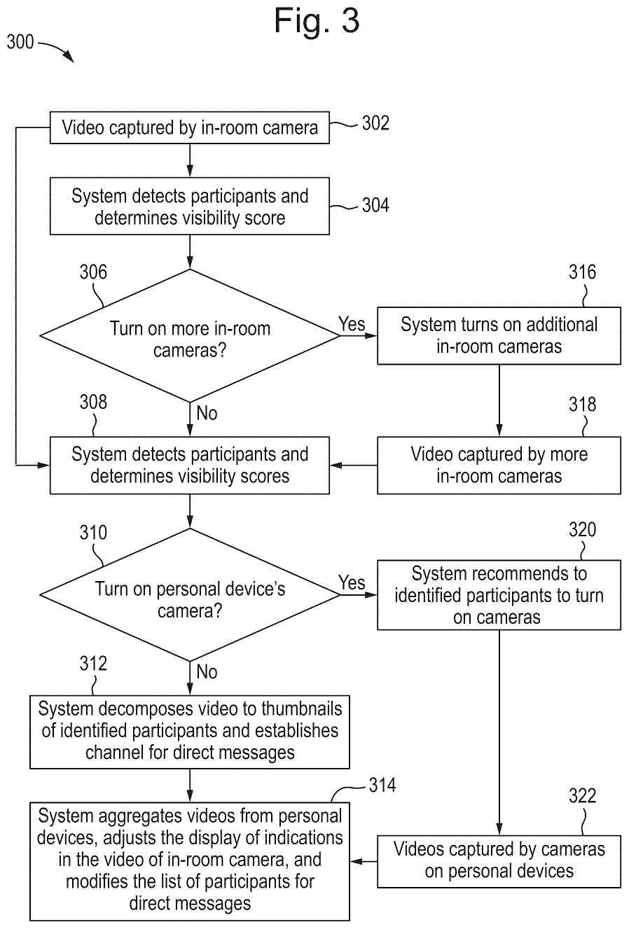

FIG. 3 depicts a flowchart describing an example 300 for providing a video conferencing session in accordance with some implementations of the disclosure.

At step 302, during a video conferencing session, the video conferencing server generates a first video captured from an in-room camera (e.g., huddle room camera) for display at a client device. The field of view of the first imaging device covers a room (e.g., huddle room). The video conferencing server then proceeds to step 304.

At step 304, the video conferencing server detects participants within the room via the analysis of the first video using an image and/or audio recognition software and a database e.g., mapping identity of people to information (e.g., biometric and/or biographical information) associated with people. The video conferencing server determines, for each detected participant in the video, a visibility score, based on e.g., on the ratio of the number of pixels comprising the visible proportion of the face area to the total number of pixels in the frame of the video. The video conferencing server then proceeds to step 306.

At step 306, the video conferencing server determines whether additional in-room cameras (e.g., additional cameras installed in the huddle room) could be turned on. In some instances, the video conferencing server determines whether one or more additional in-room cameras could be turned on if the visibility score for one or more participants in the first video is below a threshold visibility score in order to achieve a higher visibility score for the one or more participants in the one or more second videos (each captured from an additional in-room camera). If so, the video conferencing server proceeds to step 316. If not, the video conferencing server proceeds to step 308.

At step 316, the video conferencing server turns on additional in-room cameras and subsequently proceeds to step 318.

At step 318, the video conferencing server receives one or more second videos captured from the one or more additional in-room cameras and subsequently proceeds to step 308.

At step 308, when coming from step 318, the video conferencing server detects participants within the room via the analysis of the one ore more second videos using an image and/or audio recognition software and a database e.g., mapping identity of people to information (e.g., biometric and/or biographical information) associated with people. The video conferencing server determines, for each detected participant in the one or more second videos, a visibility score, based on e.g., on the ratio of the number of pixels comprising the visible proportion of the face area to the total number of pixels in the frame of video. At step 308, when coming from step 306 (based on the fact that the video conferencing server did not turn on any additional in-room cameras at step 306), the video conferencing server does not do anything. Irrespective of the previous step, the video conferencing server subsequently proceeds to step 310.

At step 310, the video conferencing server determines whether cameras from personal user devices could be turned on. In some instances, the video conferencing server determines whether one or more cameras of personal user devices (e.g., mobile phones, tablets, laptops and the likes) could be turned on if the visibility score for one or more participants in the first video and in one or more second videos is below a threshold visibility score in order to achieve a higher visibility score for the one or more participants in the one or more third videos (each captured from a camera of a personal user device). If so, the video conferencing server proceeds to step 320. If not, the video conferencing server proceeds to step 312.

At step 320, the video conferencing server may recommend or prompt participants to turn on cameras from personal user devices. In some instances, the video conferencing server recommends or prompts a participant to turn on a camera from a personal user device when the visibility score for the participant in the first video and in one or more second videos is below the threshold visibility score in order to achieve a higher visibility score for the participant in a third video (captured from the camera of the personal user device). The video conferencing server then proceeds to step 322.

At step 322, the video conferencing server receives one ore more third videos captured from cameras of personal user devices. The video conferencing server then proceeds to step 314.

At step 314, coming from step 322, the video conferencing server aggregates videos (e.g., the first video, the one or more second videos, the one or more third videos) so as to form any combinations based on the first video, the one or more second videos and the one or more third videos. The preferred combinations comprise videos (e.g., the first video, the one or more second videos and the one or more third videos) wherein each video of the combination depicts one or more participants with the highest visibility score for the one or more participants. In some examples, the video conferencing server aggregates videos from personal user devices, adjusts the display of indications in the video (e.g., first video, one ore more second videos) captured from an in-room camera and modifies the list of participants for direct messages. At step 314, coming from step 312, the video conferencing server aggregates thumbnails of identified participants, exhibiting the highest visibility scores, adjusts the display of indications in the video (e.g., first video, one ore more second videos) captured from an in-room camera and modifies the list of participants for direct messages. In some instances, the thumbnails are retrieved from a database e.g., mapping identity of people to information (e.g., biometric and/or biographical information) associated with people.

At step 312, the video conferencing server identifies participants using a database mapping identity of people to information (e.g., biometric information, biographical information) associated with people and decomposes videos captured from in-room cameras to thumbnails of identified participants, exhibiting the highest visibility scores. At step 312, the video conferencing server also establishes channels for direct messages. The video conferencing server then proceeds to step 314.

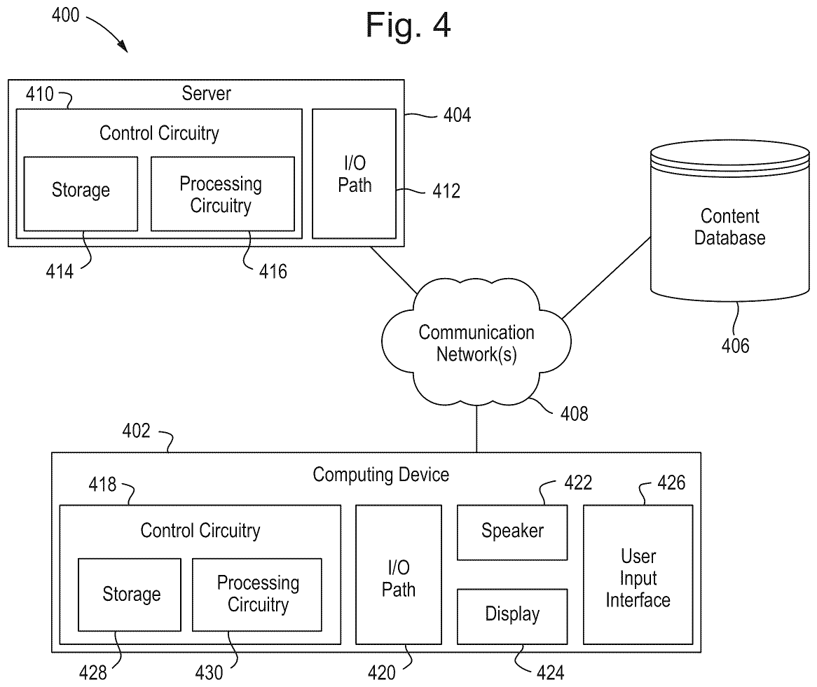

FIG. 4 illustrates a block diagram of an example system 400 for providing a video conferencing session in accordance with some implementations of the disclosure.

Although FIG. 4 shows system 400 as including a number and configuration of individual components, in some examples, any number of the components of system 400 is combined and/or integrated as one device, e.g., as a user device used by a user to control an avatar participating in a multiuser event). System 400 includes computing device 402 (e.g., a computing device comprising a camera—e.g., huddle room camera whose field of view covers the huddle room, a large display device to display live streams captured from e.g., the camera and other cameras—e.g., cameras, other than the huddle room camera, installed in the huddle room, whose field of view covers only a portion of the huddle room, or cameras from personal user devices located inside or outside the huddle room-capturing images of participants of a video conferencing session located either inside or outside the huddle room, speakers, a microphone, a computer-related medium storing the video conferencing application and a processing circuitry to run e.g., the video conferencing application), server 404 (e.g., video conferencing server), and content database 406 (e.g., database containing first videos captured from a first imaging device e.g. in-room camera whose field of view covers the room, second videos captured from second imaging device e.g., in-room camera whose field of view covers a portion of the room, camera from a personal user device as represented by personal user device depictions 108c, 110c, 112c and 114c, regenerated first videos 102a-102d), each of which is communicatively coupled to communication network 408, which is the Internet or any other suitable network or group of networks. In some examples, system 400 excludes server 404, and functionality that would otherwise be implemented by server 404 is instead implemented by other components of system 400, such as computing device 402. In still other examples, server 404 works in conjunction with computing device 402 to implement certain functionality described herein in a distributed or cooperative manner.

Server 404 includes control circuitry 410 and input/output (hereinafter “I/O”) circuitry 412, and control circuitry 410 includes storage 414 and processing circuitry 416. Computing device 402, which can be a personal computer, a laptop computer, a tablet computer, a smartphone, a smart television, a smart speaker, or any other type of computing device, includes control circuitry 418, I/O circuitry 420, speaker 422, display 424, and user input interface 426, which in some examples provides a user selectable option for enabling and disabling the display of modified closed captions. Control circuitry 418 includes storage 428 and processing circuitry 430. Control circuitry 410 and/or 418 is based on any suitable processing circuitry such as processing circuitry 416 and/or 430. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and includes a multi-core processor (e.g., dual-core, quad-core, hexa-core, or any suitable number of cores). In some examples, processing circuitry is distributed across multiple separate processors, for example, multiple of the same type of processors (e.g., two Intel Core i9 processors) or multiple different processors (e.g., an Intel Core i7 processor and an Intel Core 19 processor).

Each of storage 414, storage 428, and/or storages of other components of system 400 (e.g., storages of content database 406, and/or the like) is an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 414, storage 428, and/or storages of other components of system 400 is used to store various types of content, metadata, and or other types of data. Non-volatile memory also is used (e.g., to launch a boot-up routine and other instructions). Cloud-based storage is used to supplement storages 414, 428 or instead of storages 414, 428. In some examples, control circuitry 410 and/or 418 executes instructions for an application stored in memory (e.g., storage 414 and/or 428). Specifically, control circuitry 410 and/or 418 is instructed by the application to perform the functions discussed herein. In some implementations, any action performed by control circuitry 410 and/or 418 is based on instructions received from the application. For example, the application is implemented as software or a set of executable instructions that is stored in storage 414 and/or 428 and executed by control circuitry 410 and/or 418. In some examples, the application is a client/server application where only a client application resides on computing device 402, and a server application resides on server 404.

The application is implemented using any suitable architecture. For example, it is a stand-alone application wholly implemented on computing device 402. In such an approach, instructions for the application are stored locally (e.g., in storage 428), and data for use by the application is downloaded on a periodic basis (e.g., from an out-of-band feed, from an Internet resource, or using another suitable approach). Control circuitry 418 retrieves instructions for the application from storage 428 and process the instructions to perform the functionality described herein. Based on the processed instructions, control circuitry 418 determines what action to perform when input is received from user input interface 426.

In client/server-based examples, control circuitry 418 includes communication circuitry suitable for communicating with an application server (e.g., server 404) or other networks or servers. The instructions for carrying out the functionality described herein are stored on the application server. Communication circuitry includes a cable modem, an Ethernet card, or a wireless modem for communication with other equipment, or any other suitable communication circuitry. Such communication involves the Internet or any other suitable communication networks or paths (e.g., communication network 408). In another example of a client/server based application, control circuitry 418 runs a web browser that interprets web pages provided by a remote server (e.g., server 404). For example, the remote server stores the instructions for the application in a storage device. The remote server processes the stored instructions using circuitry (e.g., control circuitry 410) and/or generates displays. Computing device 402 receives the displays generated by the remote server and displays the content of the displays locally via display 424. This way, the processing of the instructions is performed remotely (e.g., by server 404) while the resulting displays are provided locally on computing device 402. Computing device 402 receives inputs from the user via input interface 426 and transmits those inputs to the remote server for processing and generating the corresponding displays.

A user sends instructions, e.g., to view an interactive media content item and/or selects one or more programming options of the interactive media content item, to control circuitry 410 and/or 418 using user input interface 426. User input interface 426 is any suitable user interface, such as a remote control, trackball, keypad, keyboard, touchscreen, touchpad, stylus input, joystick, speech recognition interface, gaming controller, or other user input interfaces. User input interface 426 is integrated with or combined with display 424, which can be a monitor, a television, a liquid crystal display (LCD), an electronic ink display, or any other equipment suitable for displaying visual images.

Server 404 and computing device 402 transmits and receives content and data via I/O circuitry 412 and 420, respectively. For instance, I/O circuitry 412 and/or I/O circuitry 420 includes a communication port(s) configured to transmit and/or receive (for instance to and/or from content database 406), via communication network 408, content item identifiers, content metadata, natural language queries, and/or other data. Control circuitry 410, 418 is used to send and receive commands, requests, and other suitable data using I/O circuitry 412, 420. I/O circuitry 412 of server 404 and I/O circuitry 420 of computing device 402 each comprises I/O circuitry e.g., network interface, port, bus, wire.

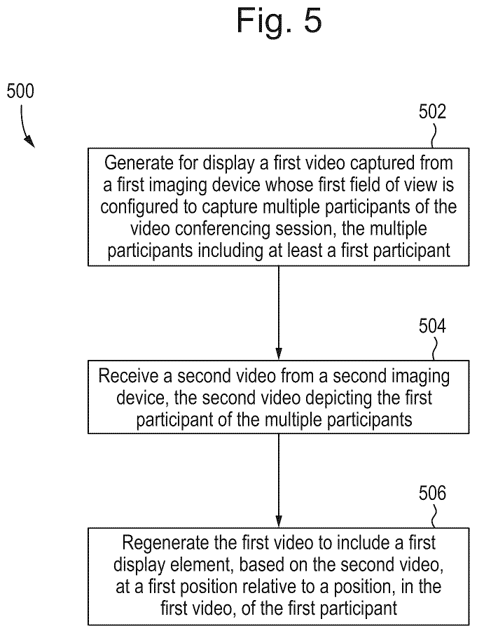

FIG. 5 represents a flowchart describing an example 500 for providing a video conferencing session in accordance with some implementations of the disclosure. Multiple participants attend a video conferencing session. A first plurality of participants attend the video conferencing session from a same room (e.g., a huddle room) equipped with a computing device comprising a camera, a large display device to display live streams captured from e.g., the camera and other cameras capturing images of participants of a video conferencing session located inside or outside the huddle room, speakers, a microphone, a computer-related medium storing the video conferencing application and a processing circuitry to run e.g., the video conferencing application. Each of the first plurality of participants may have a personal user device (e.g., mobile phone, tablet, laptop and the likes) on which a communication application (e.g., video conferencing application and/or communication application different from the video conferencing application) is active, allowing for the reception of messages during the video conferencing session. A second plurality of participants (different from the first plurality of participants) attend individually the video conferencing session from a respective location different from the room occupied by the first plurality of participants. Each of the second plurality of participants may have a personal user device (e.g., mobile phone, tablet, laptop and the likes) on which at least one communication application (e.g., video conferencing application, communication application different from the video conferencing application) is active, allowing for the reception of messages during the video conferencing session. For the second plurality of participants, the participants are identified based on credentials used to log on the video conferencing application. The following steps relate to the first plurality of participants.

At step 502, control circuitry (e.g., control circuitry of video conferencing server) generates for display (e.g., at a client device e.g., computing device 402) a first video (e.g., live stream depicting a room occupied by participants of the video conferencing session) captured from a first imaging device (e.g., in-room camera such as huddle room camera) whose first field of view is configured to capture multiple participants (e.g., represented by participant depictions 104, 106, 108, 110, 112, 114, 116 and 118) of the video conferencing session, the multiple participants including at least a first participant (e.g., represented by participant depiction 104, 106, 108, 110, 112, 114, 116 or 118). In some instances, the field of view of the first imaging device covers a room occupied by participants of the video conferencing session.

At step 504, the control circuitry (e.g., control circuitry of video conferencing server) receives a second video (e.g., live stream depicting mainly the first participant in the room occupied by the first plurality of participants of the video conferencing session) captured from a second imaging device (e.g., an in-room camera or camera from a personal user device—e.g., personal user device 108c, 110c, 112c or 114c—such as mobile phone, tablet, laptop and the likes), the second video depicting the first participant of the multiple participants. In some instances, the first and second imaging devices are located in the same room. In some instances, the field of view of the second imaging device covers a portion of the room occupied by participants of the video conferencing session.

At step 506, the control circuitry (e.g., control circuitry of video conferencing server) regenerates the first video to include a first display element, based on the second video, at a first position relative to a position, in the first video, of the first participant. In some instances, the control circuitry (e.g., control circuitry of video conferencing server) obscures the first participant depiction (e.g., participant depiction 108, 110, 112 or 114) in the first video with the first display element (e.g., first-name/at-least-one-portion-of-a-second-video overlay 108e, 110e, 112e or 114e) to generate the regenerated first video (e.g., regenerated first video 102c). In some instances, the control circuitry (e.g., control circuitry of video conferencing server) sets the first display element to comprise e.g., a first-name/at-least-one-portion-of-a-second-video overlay (e.g., first-name/at-least-one-portion-of-a-second-video overlay 108f, 110f, 112f or 114f) and a tapered-shape overlay (e.g., tapered-shape overlay 108b, 110b, 112b or 114b) corresponding to the first-name/at-least-one-portion-of-a-second-video overlay (e.g., first-name/at-least-one-portion-of-a-second-video overlay 108f, 110f, 112f or 114f): the control circuitry (e.g., control circuitry of video conferencing server) spaces first-name/at-least-one-portion-of-a-second-video overlay (e.g., first-name/at-least-one-portion-of-a-second-video overlay 108f, 110f, 112f or 114f) apart from the first participant depiction (e.g., participant depiction 108, 110, 112 or 114) in the first video by the corresponding tapered-shape overlay (e.g., tapered-shape overlay 108b, 110b, 112b or 114b) to generate the regenerated first video (e.g., the regenerated first video 102d).

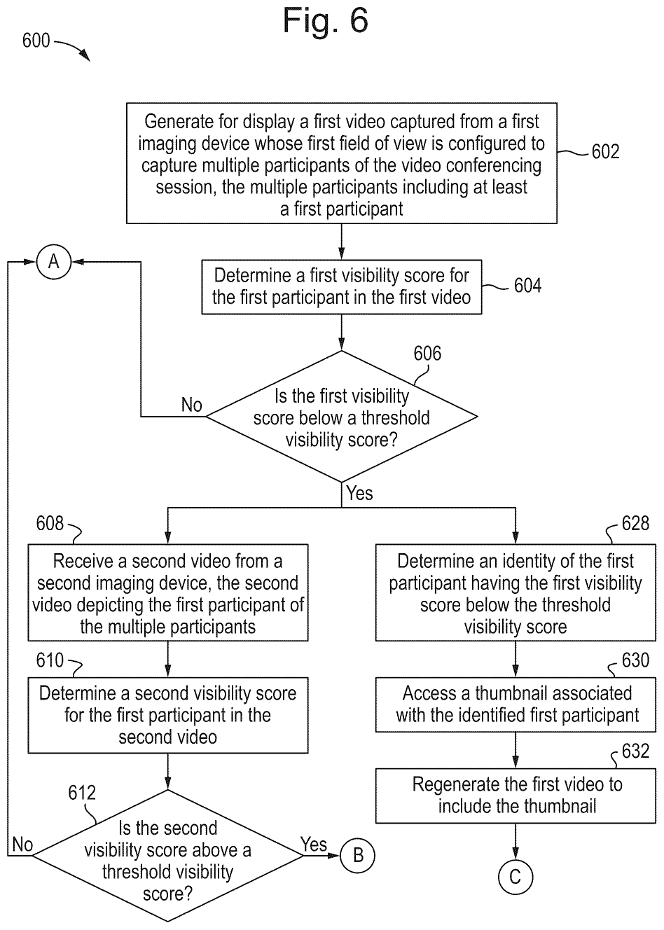

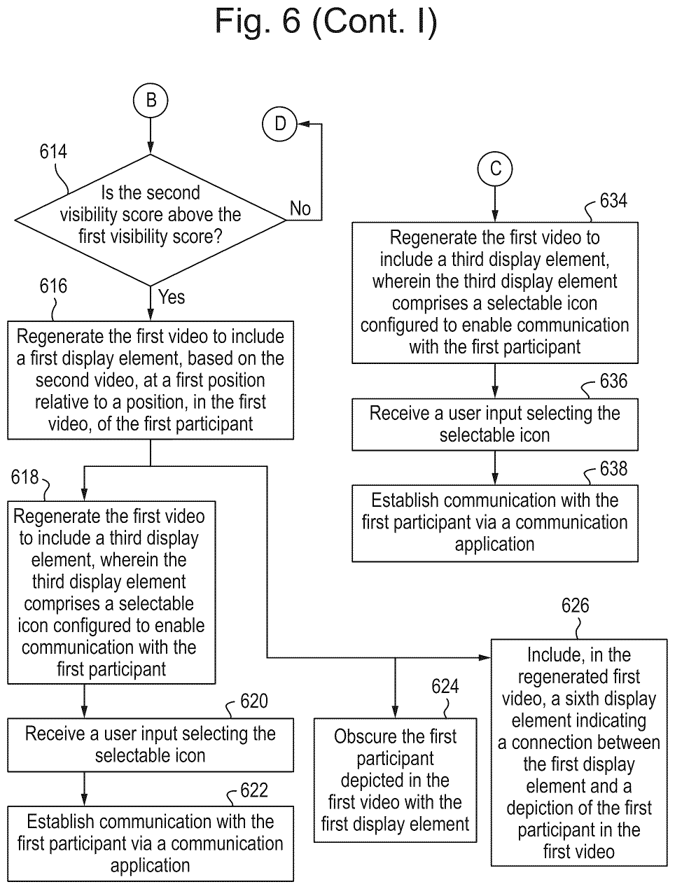

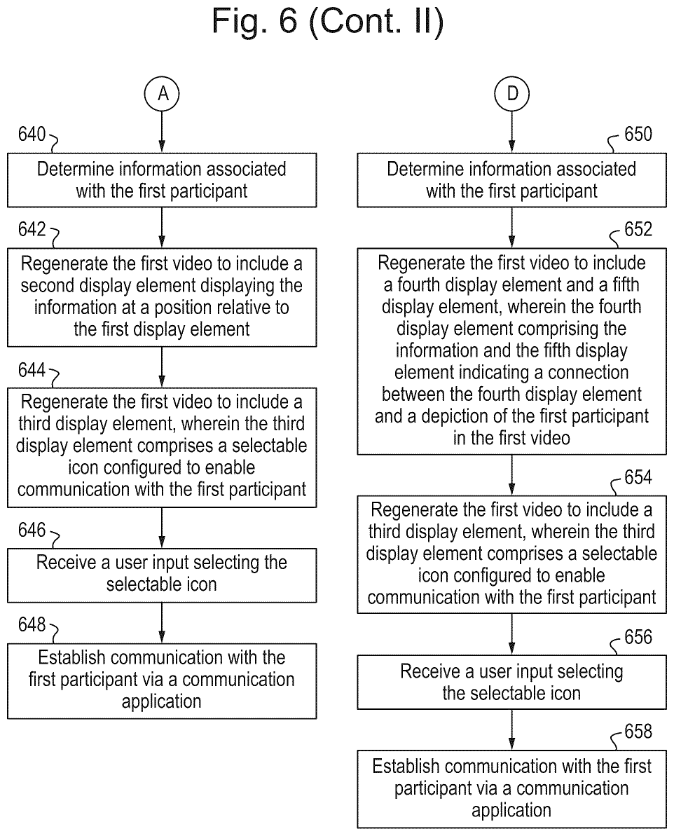

FIG. 6 represents a flowchart describing an example 600 for providing a video conferencing session in accordance with some implementations of the disclosure. Multiple participants attend a video conferencing session. A first plurality of participants attend the video conferencing session from a same room (e.g., a huddle room) equipped with a computing device comprising a camera, a large display device to display live streams captured from e.g., the camera and other cameras capturing images of participants of a video conferencing session located inside or outside the huddle room, speakers, a microphone, a computer-related medium storing the video conferencing application and a processing circuitry to run e.g., the video conferencing application. Each of the first plurality of participants may have a personal user device (e.g., mobile phone, tablet, laptop and the likes) on which a communication application (e.g., video conferencing application and/or communication application different from the video conferencing application) is active, allowing for the reception of messages during the video conferencing session. A second plurality of participants (different from the first plurality of participants) attend individually the video conferencing session from a respective location different from the room occupied by the first plurality of participants. Each of the second plurality of participants may have a personal user device (e.g., mobile phone, tablet, laptop and the likes) on which at least one communication application (e.g., video conferencing application, communication application different from the video conferencing application) is active, allowing for the reception of messages during the video conferencing session. For the second plurality of participants, the participants are identified based on credentials used to log on the video conferencing application. The following steps relate to the first plurality of participants.

At step 602, control circuitry (e.g., control circuitry of video conferencing server) generates for display (e.g., at a client device e.g., computing device 402) a first video (e.g., live stream depicting a room occupied by participants of the video conferencing session) captured from a first imaging device (e.g., in-room camera such as huddle room camera) whose first field of view is configured to capture multiple participants (e.g., represented by participant depictions 104, 106, 108, 110, 112, 114, 116 and 118) of the video conferencing session, the multiple participants including at least a first participant (e.g., represented by participant depiction 104, 106, 108, 110, 112, 114, 116 or 118). In some instances, the field of view of the first imaging device covers a room (e.g., huddle room) occupied by participants of the video conferencing session. The control circuitry (e.g., control circuitry of video conferencing server) then proceeds to step 604.

At step 604, the control circuitry (e.g., control circuitry of video conferencing server) detects the first participant within the room via the analysis of the first video using an image recognition software and determines, for the detected first participant in the first video, a first visibility score, based on e.g., on the ratio of the number of pixels comprising the visible proportion of the face area to the total number of pixels in a frame of the first video. The control circuitry (e.g., control circuitry of video conferencing server) then proceeds to step 606.

At step 606, the control circuitry (e.g., control circuitry of video conferencing server) determines whether the first visibility score is below a threshold visibility score. If so, the control circuitry (e.g., control circuitry of video conferencing server) proceeds either to step 608 or step 628. If the control circuitry (e.g., control circuitry of video conferencing server) determines that the first visibility score is not below a threshold visibility score, the control circuitry (e.g., control circuitry of video conferencing server) proceeds to step 640.

At step 608, the control circuitry (e.g., control circuitry of video conferencing server) receives a second video (e.g., live stream depicting mainly the first participant in the room occupied by the first plurality of participants of the video conferencing session) captured from a second imaging device (e.g., an in-room camera or camera from a personal user device—e.g., personal user device 108c, 110c, 112c or 114c—such as mobile phone, tablet, laptop and the likes), the second video depicting the first participant of the multiple participants. In some instances, the first and second imaging devices are located in the same room. In some instances, the field of view of the second imaging device covers a portion of the room occupied by participants of the video conferencing session. The control circuitry (e.g., control circuitry of video conferencing server) then proceeds to step 610.

At step 610, the control circuitry (e.g., control circuitry of video conferencing server) detects the first participant within the room via the analysis of the second video using the image recognition software and determines, for the detected first participant in the second video, a second visibility score, based on e.g., on the ratio of the number of pixels comprising the visible proportion of the face area to the total number of pixels in a frame of the second video. The control circuitry (e.g., control circuitry of video conferencing server) then proceeds to step 612.

At step 612, the control circuitry (e.g., control circuitry of video conferencing server) determines whether the second visibility score is below the threshold visibility score. If so, the control circuitry (e.g., control circuitry of video conferencing server) proceeds either to step 614. If the control circuitry (e.g., control circuitry of video conferencing server) determines that the first visibility score is not below a threshold visibility score, the control circuitry (e.g., control circuitry of video conferencing server) proceeds to step 640.

At step 614, the control circuitry (e.g., control circuitry of video conferencing server) determines whether the second visibility score is above the first visibility score. If so, the control circuitry (e.g., control circuitry of video conferencing server) proceeds either to step 616. If the control circuitry (e.g., control circuitry of video conferencing server) determines that the second visibility score is not above the first visibility score, the control circuitry (e.g., control circuitry of video conferencing server) proceeds to step 650.

At step 616, the control circuitry (e.g., control circuitry of video conferencing server) regenerates the first video to include a first display element e.g., a first-name/at-least-one-portion-of-a-second-video overlay (e.g., first-name/at-least-one-portion-of-a-second-video overlay 108f, 110f, 112f or 114f), based on the second video, at a first position relative to a position, in the first video, of the first participant (e.g., represented by participant depiction 108, 110, 112 or 114). The control circuitry (e.g., control circuitry of video conferencing server) then proceeds either to step 618, step 624 or step 626.

At step 618, the control circuitry (e.g., control circuitry of video conferencing server) regenerates the first video to include a third display element, wherein the third display element comprises a selectable icon (e.g., communication 108g) configured to enable communication with the first participant. The control circuitry (e.g., control circuitry of video conferencing server) then proceeds to step 620.

At step 620, the control circuitry (e.g., control circuitry of video conferencing server) receives a user input selecting the selectable icon (e.g., communication 108g). The control circuitry (e.g., control circuitry of video conferencing server) then proceeds to step 622.

At step 622, the control circuitry (e.g., control circuitry of video conferencing server) establishes communication with the first participant via a communication application (e.g., video conferencing application used for the video conferencing session, communication application different from communication application used for the video conferencing session).

At step 624, coming from step 616, the control circuitry (e.g., control circuitry of video conferencing server) obscures the first participant depiction (e.g., participant depiction 108, 110, 112 or 114) in the first video with the first display element (e.g., first-name/at-least-one-portion-of-a-second-video overlay 108e, 110e, 112e or 114e) to generate the regenerated first video (e.g., regenerated first video 102c).

At step 626, coming from step 616, the control circuitry (e.g., control circuitry of video conferencing server) includes, in the regenerated first video (e.g., the regenerated first video 102d), a sixth display element (e.g., tapered-shape overlay 108b, 110b, 112b or 114b) indicating a connection between the first display element and a depiction of the first participant (e.g., participant depiction 108, 110, 112 or 114) in the first video.

At step 628, coming from step 606, the control circuitry (e.g., control circuitry of video conferencing server) determines an identity of the first participant having the first visibility score below the threshold visibility score. In some instances, a presence of the first participant in the room e.g., huddle room is determined based on an analysis of at least one portion of the first video using an imaging and/or audio recognition software. In some instances, the identity of the first participant (whose presence in the room, e.g., huddle room is determined) is determined, using an imaging and/or audio recognition software, based on the comparison of the at least one portion of the first video (comprising audio and visual information) with biometric information (e.g., a voice signature, a set of thumbnails depicting a face taken at different angles as if a camera was rotating around the face to generates the set of thumbnails) retrieved from a database. In some instances, the database comprises information (e.g., biometric information, biographical information) associated with people and identity associated with people (e.g., one or more names such as first name, surname, or nickname, passport number, driving license number, social security number or any textual information designating a single individual): information associated with a respective person is mapped to an identity associated with the respective person. In some instances, biometric information associated with a respective person comprises e.g., a voice signature of the respective person, a set of thumbnails depicting a face of the respective person taken at different angles as if a camera was rotating around the face of the person to generate the set of thumbnails. In some instances, the set of thumbnails comprises high-quality and high-resolution thumbnails of the respective person that are part of the first display element included in the regenerated first video. In some instances, biographical information associated with a respective person comprises at least one of e.g., professional status (e.g., job title, unemployed status, student status, professional profile pulled from a social network e.g., LinkedIn®) of the respective person, organization (e.g., company, governmental organization, non-governmental organization, political movement) to which the respective person belongs and one or more keywords related to the person (e.g., quote pronounced by the respective person, biographical elements related to the respective person, biographical stages of the first participant, at least one portion of the Curriculum Vitae of the first participant). In some instances, the database is anonymized e.g., for security purpose. In some instances, only a part of said database is employed based on a list of participants established after people that were forwarded invitations to attend the video conferencing session confirmed or likely predicted their future participation to the video conferencing session. The control circuitry (e.g., control circuitry of video conferencing server) then proceeds to step 630.

At step 630, the control circuitry (e.g., control circuitry of video conferencing server) accesses a thumbnail (e.g., thumbnail from first-name/thumbnail overlay 108d, 110d, 112d or 114d) associated with the identified first participant. In some instances, the control circuitry (e.g., control circuitry of video conferencing server) retrieves, from a database, the thumbnail of the first participant. In some instances, the database maps the identity of the first participant (e.g., one or more names such as first name, surname, or nickname, passport number, driving license number, social security number or any textual information designating the first participant) to information (e.g., biometric information, biographical information) associated with the first participant. In some instances, biometric information associated with the first participant comprises e.g., a voice signature of the first participant, a set of thumbnails depicting a face of the first participant taken at different angles as if a camera was rotating around the face to generate the set of thumbnails. In some instances, biographical information associated with the first participant comprises at least one of birth date, birth place, nationality, residence place, professional status (e.g., job title, unemployed status, student status, professional profile pulled from a social network e.g., LinkedIn®) of the first participant, organization (e.g., company, governmental organization, non-governmental organization, political movement) in which the first participant works, or one or more keywords related to the first participant (e.g., quote pronounced by the first participant, biographical elements related to the first participant, at least one portion of the Curriculum Vitae of the first participant). In some instances, the database is anonymized e.g., for security purposes. The control circuitry (e.g., control circuitry of video conferencing server) then proceeds to step 632.

Alternatively, at step 630, the control circuitry (e.g., control circuitry of video conferencing server) accesses a second video (e.g., captured from a second imaging device such as a personal user device e.g., mobile phone, tablet, laptop and the likes) associated with the identified first participant. In some instances, the control circuitry (e.g., control circuitry of video conferencing server) accesses a second video (e.g., captured from a second imaging device such as a personal user device e.g., mobile phone, tablet, laptop and the likes) associated with the identified first participant, when the first participant is speaking. In some instances, the database maps the identity of the first participant (e.g., one or more names such as first name, surname, or nickname, passport number, driving license number, social security number or any textual information designating the first participant) to information (e.g., biometric information, biographical information) associated with the first participant. In some instances, biometric information associated with the first participant comprises e.g., a voice signature of the first participant, a set of thumbnails depicting a face of the first participant taken at different angles as if a camera was rotating around the face to generate the set of thumbnails. In some instances, biographical information associated with the first participant comprises at least one of birth date, birth place, nationality, residence place, professional status (e.g., job title, unemployed status, student status, professional profile pulled from a social network e.g., LinkedIn®) of the first participant, organization (e.g., company, governmental organization, non-governmental organization, political movement) in which the first participant works, or one or more keywords related to the first participant (e.g., quote pronounced by the first participant, biographical elements related to the first participant, at least one portion of the Curriculum Vitae of the first participant). In some instances, the database is anonymized e.g., for security purposes. The control circuitry (e.g., control circuitry of video conferencing server) then proceeds to step 632.

At step 632, the control circuitry (e.g., control circuitry of video conferencing server) regenerates the first video to include the thumbnail (e.g., thumbnail from first-name/thumbnail overlay 108d, 110d, 112d or 114d in regenerated firs video 102b). The control circuitry (e.g., control circuitry of video conferencing server) then proceeds to step 634.

Alternatively, at step 632, the control circuitry (e.g., control circuitry of video conferencing server) regenerates the first video to include at least one portion of the second video by overlaying an at-least-one-portion-of-second-video overlay (e.g., each at-least-one-portion-of-second-video overlay in first-name/at-least-one-portion-of-a-second-video overlays 108e, 110e, 112e and 114e located in regenerated first video 102c) upon the first participant depiction in the first video, or by overlaying an at-least-one-portion-of-second-video overlay (each at-least-one-portion-of-second-video overlay in first-name/at-least-one-portion-of-a-second-video overlays 108f, 110f, 112f and 114f located in regenerated first video 102d) outside the first participant depiction in the first video. The control circuitry (e.g., control circuitry of video conferencing server) then proceeds to step 634.

At step 634, the control circuitry (e.g., control circuitry of video conferencing server) regenerates the first video to include a third display element, wherein the third display element comprises a selectable icon (e.g., communication 108g) configured to enable communication with the first participant. The control circuitry (e.g., control circuitry of video conferencing server) then proceeds to step 636.

At step 636, the control circuitry (e.g., control circuitry of video conferencing server) receives a user input selecting the selectable icon (e.g., communication 108g). The control circuitry (e.g., control circuitry of video conferencing server) then proceeds to step 638.

At step 638, the control circuitry (e.g., control circuitry of video conferencing server) establishes communication with the first participant via a communication application (e.g., video conferencing application used for the video conferencing session, communication application different from communication application used for the video conferencing session).

At step 640, coming from either step 606 or step 612, the control circuitry (e.g., control circuitry of video conferencing server) determines information associated with the first participant. In some instances, information associated with the first participant comprises at least one of a tuple (comprising at least one of e.g., one or more names such as first name, surname, or nickname or any textual information designating a single individual), biometric information and biographical information associated with the first participant. In some instances, biometric information associated with the first participant comprises e.g., a voice signature of the person, a set of thumbnails depicting a face of the person taken at different angles as if a camera was rotating around the face to generate the set of thumbnails. In some instances, biographical information associated with the first participant comprises at least one of professional status (e.g., job title, unemployed status, student status, professional profile pulled from a social network e.g., LinkedIn®) of the first participant, organization (e.g., company, governmental organization, non-governmental organization, political movement) in which the first participant work or one or more keywords related to the first participant (e.g., quote pronounced by the first participant, biography steps related to the first participant). The control circuitry (e.g., control circuitry of video conferencing server) then proceeds to 642.

At step 642, the control circuitry (e.g., control circuitry of video conferencing server) regenerates the first video to include a second display element (e.g., first name overlay 104a, 106a, 116a and 118a) displaying the information at a position relative to the first display element. The control circuitry (e.g., control circuitry of video conferencing server) then proceeds to 644.

At step 644, the control circuitry (e.g., control circuitry of video conferencing server) regenerates the first video to include a third display element, wherein the third display element comprises a selectable icon (e.g., communication 108g) configured to enable communication with the first participant. The control circuitry (e.g., control circuitry of video conferencing server) then proceeds to step 646.

At step 646, the control circuitry (e.g., control circuitry of video conferencing server) receives a user input selecting the selectable icon (e.g., communication 108g). The control circuitry (e.g., control circuitry of video conferencing server) then proceeds to step 648.

At step 648, the control circuitry (e.g., control circuitry of video conferencing server) establishes communication with the first participant via a communication application (e.g., video conferencing application used for the video conferencing session, communication application different from communication application used for the video conferencing session).

At step 650, coming from step 614, the control circuitry (e.g., control circuitry of video conferencing server) determines information associated with the first participant. In some instances, information associated with the first participant comprises at least one of a tuple (comprising at least one of e.g., one or more names such as first name, surname, or nickname, or any textual information designating a single individual), biometric information and biographical information associated with the first participant. In some instances, biometric information associated with the first participant comprises e.g., a voice signature of the person, a set of thumbnails depicting a face of the person taken at different angles as if a camera was rotating around the face to generate the set of thumbnails. In some instances, biographical information associated with the first participant comprises at least one of professional status (e.g., job title, unemployed status, student status, professional profile pulled from a social network e.g., LinkedIn®) of the first participant, organization (e.g., company, governmental organization, non-governmental organization, political movement) in which the first participant work or one or more keywords related to the first participant (e.g., quote pronounced by the first participant, biography steps related to the first participant). The control circuitry (e.g., control circuitry of video conferencing server) then proceeds to 652.

At step 652, the control circuitry (e.g., control circuitry of video conferencing server) regenerates the first video to include a fourth display element and a fifth display element, wherein the fourth display element comprising the information (e.g., biometric information such as thumbnail overlay 108d, 110d, 112d or 114d, identity information such as first-name overlay 108a, 110a, 112a or 114a, biographical information associated with the first participant) and the fifth display element indicating a connection between the fourth display element and a depiction of the first participant in the first video. In some instances, information associated with the first participant comprises at least one of a tuple (comprising at least one of e.g., one or more names such as first name, surname, or nickname, or any textual information designating a single individual), biometric information and biographical information associated with the first participant. In some instances, biometric information associated with the first participant comprises e.g., a voice signature of the person, a set of thumbnails depicting a face of the person taken at different angles as if a camera was rotating around the face to generate the set of thumbnails. In some instances, biographical information associated with the first participant comprises at least one of professional status (e.g., job title, unemployed status, student status, professional profile pulled from a social network e.g., LinkedIn®) of the first participant, organization (e.g., company, governmental organization, non-governmental organization, political movement) in which the first participant work or one or more keywords related to the first participant (e.g., quote pronounced by the first participant, biography steps related to the first participant). The control circuitry (e.g., control circuitry of video conferencing server) then proceeds to 654.

At step 654, the control circuitry (e.g., control circuitry of video conferencing server) regenerates the first video to include a third display element, wherein the third display element comprises a selectable icon (e.g., communication 108g) configured to enable communication with the first participant. The control circuitry (e.g., control circuitry of video conferencing server) then proceeds to step 656.

At step 656, the control circuitry (e.g., control circuitry of video conferencing server) receives a user input selecting the selectable icon (e.g., communication 108g). The control circuitry (e.g., control circuitry of video conferencing server) then proceeds to step 658.

At step 658, the control circuitry (e.g., control circuitry of video conferencing server) establishes communication with the first participant via a communication application (e.g., video conferencing application used for the video conferencing session, communication application different from communication application used for the video conferencing session).

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for providing a video conferencing session, the method comprising:
generating for display a first video captured from a first imaging device whose first field of view is configured to capture multiple participants of the video conferencing session, the multiple participants including at least a first participant;
receiving a second video captured from a second imaging device, the second video depicting the first participant of the multiple participants; and
regenerating the first video to include a first display element, based on the second video, at a first position relative to a position, in the first video, of the first participant.

2. The method of claim 1, wherein the receiving the second video further comprises:
determining that a first visibility score for the first participant in the first video is below a threshold visibility score;
determining that a second visibility score for the first participant in the second video is above the threshold visibility score; and
causing the first video to be regenerated when the second visibility score is higher than the first visibility score.

3. The method of claim 1, comprising:
determining that a first visibility score for the first participant in the first video is below a threshold visibility score;
determining an identity of the first participant having the first visibility score below the threshold visibility score;
accessing a thumbnail associated with the identified first participant; and
regenerating the first video to include the thumbnail.

4. The method of claim 1, wherein the determining the first visibility score comprises:
determining, based on a frame of the first video at least one of:
a visible proportion of a face area of the first participant;
a number of pixels comprising the visible proportion of the face area of the first participant; and
a ratio of the number of pixels comprising the visible proportion of the face area to a total number of pixels in the frame.

5. The method of claim 1, further comprising:
determining information associated with the first participant; and
regenerating the first video to include a second display element displaying the information at a position relative to the first display element.

6. The method of claim 1, wherein the first display element is configured to obscure the first participant depicted in the first video.

7. The method of claim 1, further comprising:
regenerating the first video to include a third display element, wherein the third display element comprises a selectable icon configured to enable communication with the first participant;
receiving a user input selecting the selectable icon; and
establishing communication with the first participant via a communication application.

8. The method of claim 7, wherein the establishing communication with the first participant comprises:
determining that the second imaging device is part of a user device of the first participant;
determining that at least one communication application is active on the user device of the first participant; and
selecting the at least one communication application to receive the communication.

9. The method of claim 1, further comprising:
determining that a second visibility score for the first participant in the second video is below a first visibility score for the first participant in the first video;
determining information associated with the first participant; and
regenerating the first video to include a fourth display element and a fifth display element, wherein:
the fourth display element comprising the information; and
the fifth display element indicating a connection between the fourth display element and a depiction of the first participant in the first video.

10. The method of claim 1, wherein the regenerating the first video comprises:
including, in the regenerated first video, a sixth display element indicating a connection between the first display element and a depiction of the first participant in the first video.

11. A system for providing a video conferencing session, the system comprising:
control circuitry configured to:
generate for display a first video captured from a first imaging device whose first field of view is configured to capture multiple participants of the video conferencing session, the multiple participants including at least a first participant;
input/output circuitry configured to:
receive a second video captured from a second imaging device, the second video depicting the first participant of the multiple participants; and
wherein the control circuitry is further configured to:
regenerate the first video to include a first display element, based on the second video, at a first position relative to a position, in the first video, of the first participant.

12. The system of claim 11, wherein the input/output circuitry is configured to receive the second video by having the control circuitry further configured to:
determine that a first visibility score for the first participant in the first video is below a threshold visibility score;
determine that a second visibility score for the first participant in the second video is above the threshold visibility score; and
cause the first video to be regenerated when the second visibility score is higher than the first visibility score.

13. The system of claim 11, wherein the control circuitry is further configured to:
determine that a first visibility score for the first participant in the first video is below a threshold visibility score;
determine an identity of the first participant having the first visibility score below the threshold visibility score;
access a thumbnail associated with the identified first participant; and
regenerate the first video to include the thumbnail.

14. The system of claim 11, wherein the control circuitry is further configured to determine the first visibility score by:
determining, based on a frame of the first video at least one of:
a visible proportion of a face area of the first participant;
a number of pixels comprising the visible proportion of the face area of the first participant; and
a ratio of the number of pixels comprising the visible proportion of the face area to a total number of pixels in the frame.

15. The system of claim 11, wherein the control circuitry is further configured to:
determine information associated with the first participant; and
regenerate the first video to include a second display element displaying the information at a position relative to the first display element.

16. The system of claim 11, wherein the first display element is configured to obscure the first participant depicted in the first video.

17. The system of claim 11, wherein the control circuitry is further configured to:
regenerate the first video to include a third display element, wherein the third display element comprises a selectable icon configured to enable communication with the first participant;
receive a user input selecting the selectable icon; and
establish communication with the first participant via a communication application.

18. The system of claim 17, wherein the control circuitry is further configured to establish communication with the first participant by:
determining that the second imaging device is part of a user device of the first participant;
determining that at least one communication application is active on the user device of the first participant; and
selecting the at least one communication application to receive the communication.

19. The system of claim 11, wherein the control circuitry is further configured to:
determine that a second visibility score for the first participant in the second video is below a first visibility score for the first participant in the first video;
determine information associated with the first participant; and
regenerate the first video to include a fourth display element and a fifth display element, wherein:
the fourth display element comprising the information; and
the fifth display element indicating a connection between the fourth display element and a depiction of the first participant in the first video.

20. The system of claim 11, wherein the control circuitry is further configured to regenerate the first video by:
including, in the regenerated first video, a sixth display element indicating a connection between the first display element and a depiction of the first participant in the first video.

21-50. (canceled)
